(19) United States
(12) Patent Application Publication
(10) Pub. No.: US 2019/0107929 A1
(43) Pub. Date: Apr. 11, 2019

(54) METHOD AND DEVICE FOR LOADING CONTENT OF PAGE, AND ELECTRONIC DEVICE

(71) Applicant: BEIJING KINGSOFT INTERNET SECURITY SOFTWARE CO., LTD., Beijing (CN)

(72) Inventors: Zhongyi Peng, Beijing (CN); Wenyuan Chi, Beijing (CN)

(73) Assignee: BEIJING KINGSOFT INTERNET SECURITY SOFTWARE CO., LTD., Beijing (CN)

(21) Appl. No.: 16/202,301

(22) Filed: Nov. 28, 2018

Related U.S. Application Data
(63) Continuation of application No. PCT/CN2017/073975, filed on Feb. 17, 2017.

(30) Foreign Application Priority Data
Jun. 23, 2016 (CN) 201610463159.6

(51) Int. Cl. G06F 3/0483; G06F 16/957; G06F 3/0486; G06F 3/0488

(52) U.S. Cl. CPC G06F 3/0483; G06F 3/04883; G06F 3/0486; G06F 16/9577

(57) ABSTRACT

Embodiments of the present disclosure provide a method and a device for loading content of a page, and an electronic device. The method includes: detecting a dragging operation input by a user on a current webpage; in response to detecting that the current webpage is dragged to, by the user, begin to display content of a last whole page above bottom of the current webpage, obtaining a ratio of content not displayed in the last whole page to the last whole page; and in response to the ratio being equal to a predetermined ratio, loading customized content below the bottom of the current webpage.

### CROSS-REFERENCE TO RELATED APPLICATION

This application is a continuation of International Patent Application No. PCT/CN2017/073975, filed with the State Intellectual Property Office of P. R. China on Feb. 17, 2017, which claims priority to Chinese Patent Application Serial No. 201610463159.6, filed on Jun. 23, 2016, the entire contents of both of which are incorporated herein by reference.

### FIELD

The present disclosure relates to a field of webpage content browsing technology, and more particularly to a method for loading content of a page, a device for loading content of a page, and an electronic device.

### BACKGROUND

At present, mobile devices, such as mobile phones, smart phones, smart watches, smart terminals and so on, have gradually become an indispensable tool in people's daily life. A user may interact with an operating system of a mobile device via sliding screen on the mobile device. The mobile device responds to a sliding gesture of the user, and loads and displays an interface and content information in the screen of the mobile device.

When the user views webpage information on the mobile device, the user may generally drags a webpage by a gesture of sliding up or down. Since page information capacity varies with different website, when the webpage is continuously dragged until to the bottom of the webpage during the user viewing the webpage, there may be a situation that the webpage cannot be dragged further because all the page content is already loaded, thus content that is of interest to the user cannot continue to be provided to the user on the current page.

### SUMMARY

A method for loading content of a page is provided. The method includes: detecting a dragging operation input by a user on a current webpage; in response to detecting that the current webpage is dragged to, by the user, begin to display content of a last whole page above bottom of the current webpage, obtaining a ratio of content not displayed in the last whole page to the last whole page; and in response to the ratio being equal to a predetermined ratio, loading customized content below the bottom of the current webpage.

A device for loading content of a page is provided. The device for loading content of a page includes: a detecting unit, configured to detect a dragging operation input by a user on a current webpage; an obtaining unit, configured to, in response to detecting, by the detecting unit, that the current webpage is dragged to, by the user, begin to display content of a last whole page above bottom of the current webpage, obtain a ratio of content not displayed in the last whole page to the last whole page; and a first loading unit, configured to, in response to the ratio being equal to a predetermined ratio, load customized content below the bottom of the current webpage.

An electronic device is provided. The electronic device includes: a housing, a processor, a memory, a circuit board, and a power circuit. The circuit board is arranged inside a space enclosed by the housing; the processor and the memory are disposed on the circuit board. The power circuit is configured to provide power for individual respective circuits or components of the mobile terminal. The memory is configured to store executable program codes. The processor, by reading the executable program code stored in the memory, is configured to run a program corresponding to the executable program codes by reading the executable program codes stored in the memory, so as to perform any method for loading content of a page above-mentioned.

### BRIEF DESCRIPTION OF THE DRAWINGS

In order to explicitly illustrate technical solutions in embodiments of the present disclosure, a brief introduction for the accompanying drawings used when describing the embodiments will be listed as follows. Apparently, the drawings described below are only corresponding to some embodiments of the present disclosure, and those skilled in the art may obtain other drawings according to these drawings without creative labor.

FIG. 1 is a flow chart of a method for loading content of a page according to a first embodiment of the present disclosure;

FIG. 2 is a schematic diagram illustrating examples of a current webpage, a last whole page, and a currently displayed page according to an embodiment of the present disclosure;

FIG. 3 is a flow chart of a method for loading content of a page according to a second embodiment of the present disclosure;

FIG. 4 is a block diagram illustrating a device for loading content of a page according to a first embodiment of the present disclosure;

FIG. 5 is a block diagram illustrating a device for loading content of a page according to a second embodiment of the present disclosure;

FIG. 6 is a block diagram illustrating an electronic device according to an embodiment of the present disclosure.

### DETAILED DESCRIPTION

Technical solutions in embodiments of the present disclosure will be described in detail in combination drawings.

It should be noted that, the described embodiments are only part of embodiments of the present disclosure, instead of the entire embodiments. Based on embodiments described herein, those skilled in the art may obtain all other embodiments without creative labor, which belongs to the protection scope of the present disclosure.

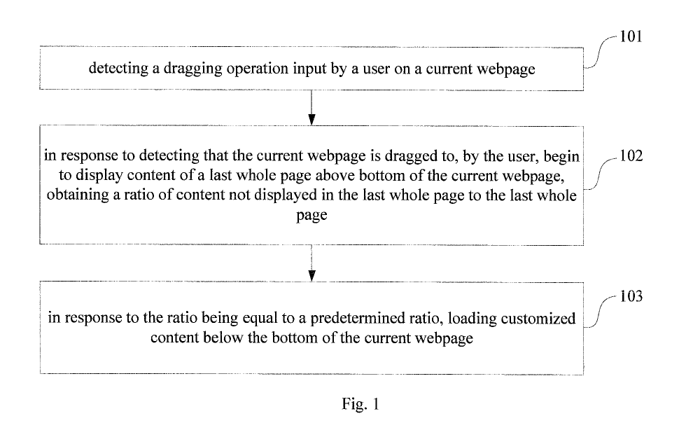

FIG. 1 is a flow chart of a method for loading content of a page according to a first embodiment of the present disclosure. As illustrated in FIG. 1, the method according to this embodiment may include follows.

At block 101, a dragging operation input by a user on a current webpage is detected.

In this embodiment, a webpage address that a user requests to access is obtained. A webpage browsing request is sent to a website server according to the webpage address. Webpage codes are obtained from the website server. Then the webpage codes are parsed, webpage content is typeset and displayed, and the current webpage is displayed. The current webpage contains the webpage content corresponding to all the webpage codes obtained according to the webpage address.

In some embodiments, the current webpage may be longer than a displaying screen, thus the displaying screen can only display a part of the current webpage. In this situation, the user may perform the dragging operation on the current webpage to view all the webpage content contained in the current webpage.

At block 102, in response to detecting that the current webpage is dragged to, by the user, begin to display content of a last whole page above bottom of the current webpage, a ratio of content not displayed in the last whole page to the last whole page is obtained.

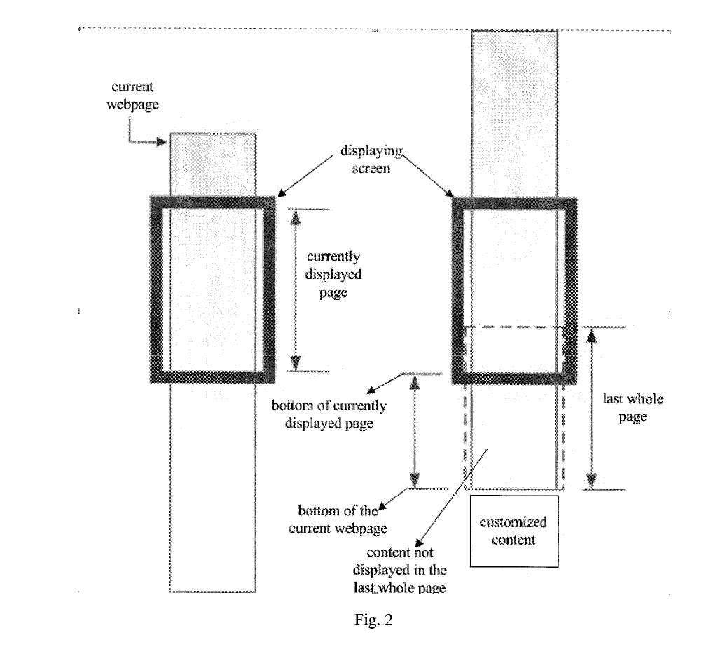

In some embodiments, in the situation that the current webpage is longer than the displaying screen, content displayed in the displaying screen in real time may be called as a currently displayed page. For example, as illustrated in FIG. 2, the currently displayed page corresponds to the content displayed in the displaying screen. The last whole page is a last part of the current webpage that is displayed in the displaying screen. That is, the last whole page is a part of the current webpage that is to be displayed in the displaying screen when the current webpage is dragged to the bottom. For example, as illustrated in FIG. 2, the last whole page corresponds to the content in the dashed box.

During dragging the current webpage, there may be a process in which only a part of the last whole page is displayed in the displaying screen before the current webpage is dragged to the bottom. In this situation, the last whole page is divided into two parts: the part displayed in the displaying screen and a part not displayed in the screen. The part not displayed in the screen is the content not displayed in the last whole page. For example, as illustrated in FIG. 2, the content not displayed in the last whole page corresponds to the content from the bottom of the currently displayed page to the bottom of the current webpage.

In this embodiment, a distance between the bottom of the currently displayed page and the bottom of the current webpage, and a height of the last whole page are obtained. A ratio is obtained by dividing the distance between the bottom of the currently displayed page and the bottom of the current webpage by the height of the last whole page. The obtained ratio is the ratio of the content not displayed in the last whole page to the last whole page.

At block 103, in response to the ratio being equal to a predetermined ratio, customized content is loaded below the bottom of the current webpage.

In this embodiment, a first predetermined number of content data blocks may be obtained from cloud. Then the first predetermined number of content data blocks is loaded below the bottom of the current webpage in a card information flow mode. Each content data block includes an image and a link. When a user clicks the image or the link, a detailed page may be jumped to.

In an embodiment of the present disclosure, a first predetermined number of content data blocks matching with webpage accessing record of the user may be obtained. That matching with webpage accessing record of the user refers to matching with using habit of the user or having a high user accessing frequency. Thereby, content that is of interest to the user may be obtained. In detail, the customized content may be advertisement, news, a video, or the like.

The predetermined ratio may be a value between 0 and 100, thus content data blocks of the customized content may be fully loaded before the last whole page above the bottom of the current webpage is fully displayed and after the last whole page above the bottom of current webpage began to be displayed, such that the card information flow may be loaded without buffer after the webpage is dragged to the bottom.

In this embodiment, when it is detected that the user drags the current webpage to begin to display content of the last whole page above the bottom of the current webpage, and when the ratio of the content not displayed in the last whole page to the last whole page is obtained, the customized content is loaded below the bottom of the current webpage. Compared with the related art, with embodiments of the present disclosure, the customized content may be continuously loaded at the bottom of the page according to the user's dragging operation before the user drags the page to the bottom of the page, thereby, the content of interest to the user can be seamlessly connected with the content that the user is viewing, thus convenient for the user to obtain the content of interest on the current page.

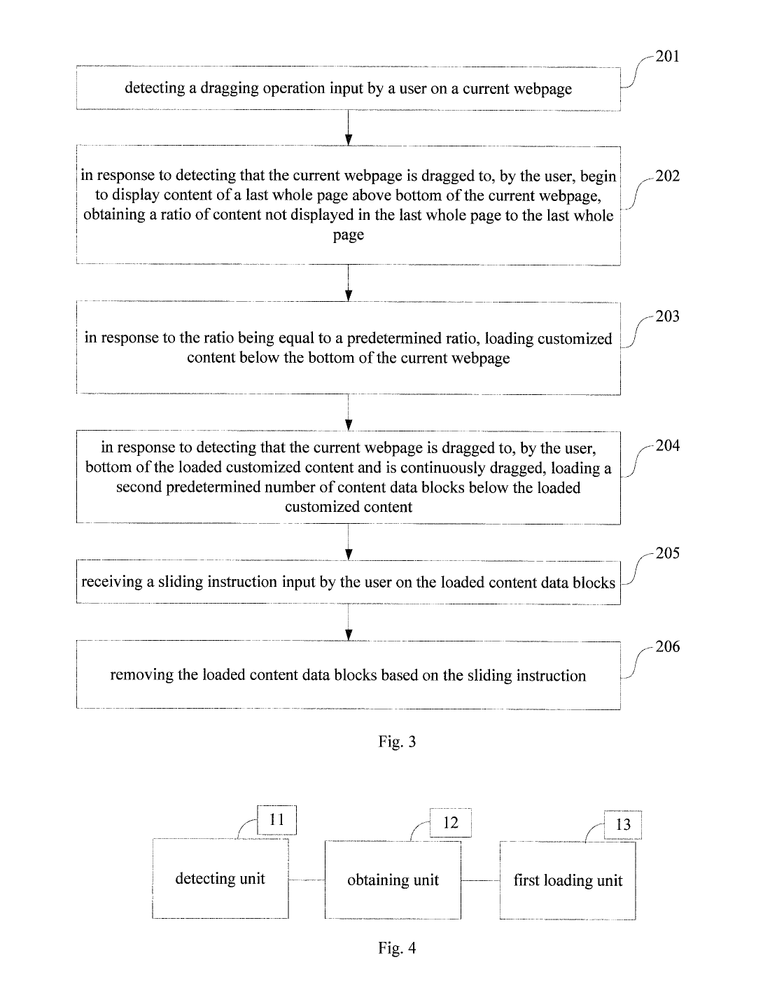

FIG. 3 is a flow chart of a method for loading content of a page according to a second embodiment of the present disclosure. As illustrated in FIG. 3, the method according to this embodiment may include follows.

At block 201, a dragging operation input by a user on a current webpage is detected.

In this embodiment, the process of detecting the dragging operation input by the user on the current webpage is similar to the step at block 101 in above-mentioned method embodiment, which is not elaborated herein.

At block 202, in response to detecting that the current webpage is dragged to, by the user, begin to display content of a last whole page above bottom of the current webpage, a ratio of content not displayed in the last whole page to the last whole page is obtained.

In this embodiment, the process of obtaining the ratio of the content not displayed in the last whole page to the last whole page is similar to the step at block 102 in above-mentioned method embodiment, which is not elaborated herein.

At block 203, in response to the ratio being equal to a predetermined ratio, customized content is loaded below the bottom of the current webpage.

In this embodiment, the process of loading the customized content below the bottom of the current webpage is similar to the step at block 103 in above-mentioned method embodiment, which is not elaborated herein. Further, the obtained first predetermined number of content data blocks may be firstly cached. In response to detecting that the current webpage is dragged to, by the user, the bottom of the current webpage and is continuously dragged, the cached first predetermined number of content data blocks is loaded below the bottom of the current webpage.

If the first predetermined number of content data blocks is never loaded after the first predetermined number of content data blocks is cached and if a time period that the first predetermined number of content data blocks is cached does not exceed a preset caching time limit, the cached content data blocks do not need to be re-acquired from the cloud and the cached content data blocks can be directly used when the page content loading is performed on the same webpage next time.

In addition, if no new content data block is obtained from the cloud when the page content loading is performed, the cached content data blocks may be loaded, no matter how many times the cached content data blocks is loaded. However, if the time period that the content data blocks are cached exceeds the preset caching time limit, the cached content data blocks are not loaded any more.

At block 204, in response to detecting that the current webpage is dragged to, by the user, bottom of the loaded customized content and is continuously dragged, a second predetermined number of content data blocks is loaded below the loaded customized content.

In this embodiment, if the user continues to drag the webpage when the current webpage is dragged by the user until the loaded customized content is fully displayed, a same number of content data blocks may be further loaded below the loaded customized content, thus satisfying the user's viewing demand.

In an embodiment of the present disclosure, a feature of the current webpage may be obtained, the feature of the current webpage may be matched with a content format base, and the second predetermined number of content data blocks matching with the feature of the current webpage is obtained. Then the second predetermined number of content data blocks matching with the feature of the current webpage is loaded below the loaded customized content.

At block 205, a sliding instruction input by the user on the loaded content data blocks is received.

In this embodiment, when the user does not wish to continue viewing the loaded customized content, part or all of the loaded content data blocks may be selected, and a sliding operation may be performed on the selected loaded content data blocks.

At block 206, the loaded content data blocks is removed based on the sliding instruction.

In this embodiment, when the user selects part or all of the loaded content data blocks, and performs the sliding operation on the selected loaded content data blocks, an electronic device receives the sliding instruction, and removes the part or all of the loaded content data blocks that selected by the user.

In this embodiment, when it is detected that the user drags the current webpage to begin to display content of the last whole page above the bottom of the current webpage, and when the ratio of the content not displayed in the last whole page to the last whole page is obtained, the customized content is loaded below the bottom of the current webpage, Compared with the related art, with embodiments of the present disclosure, the customized content may be continuously loaded at the bottom of the page according to the user's dragging operation before the user drags the page to the bottom of the page, thereby, the content of interest to the user can be seamlessly connected with the content that the user is viewing, thus convenient for the user to obtain the content of interest on the current page.

FIG. 4 is a block diagram illustrating a device for loading content of a page according to a first embodiment of the present disclosure. As illustrated in FIG. 4, the device according to this embodiment may include: a detecting unit 11, an obtaining unit 12, and a first loading unit 13. The detecting unit 11 is configured to detect a dragging operation input by a user on a current webpage. The obtaining unit 12 is configured to, in response to detecting, by the detecting unit, that the current webpage is dragged to, by the user, begin to display content of a last whole page above bottom of the current webpage, obtain a ratio of content not displayed in the last whole page to the last whole page. The first loading unit 13 is configured to, in response to the ratio being equal to a predetermined ratio, load customized content below the bottom of the current webpage.

The device according to embodiments of the present disclosure may be used to implement the technical solution of the method embodiment illustrated in FIG. 1. Implementation principle and technical effect of the device and the method are similar, which are not be elaborated herein.

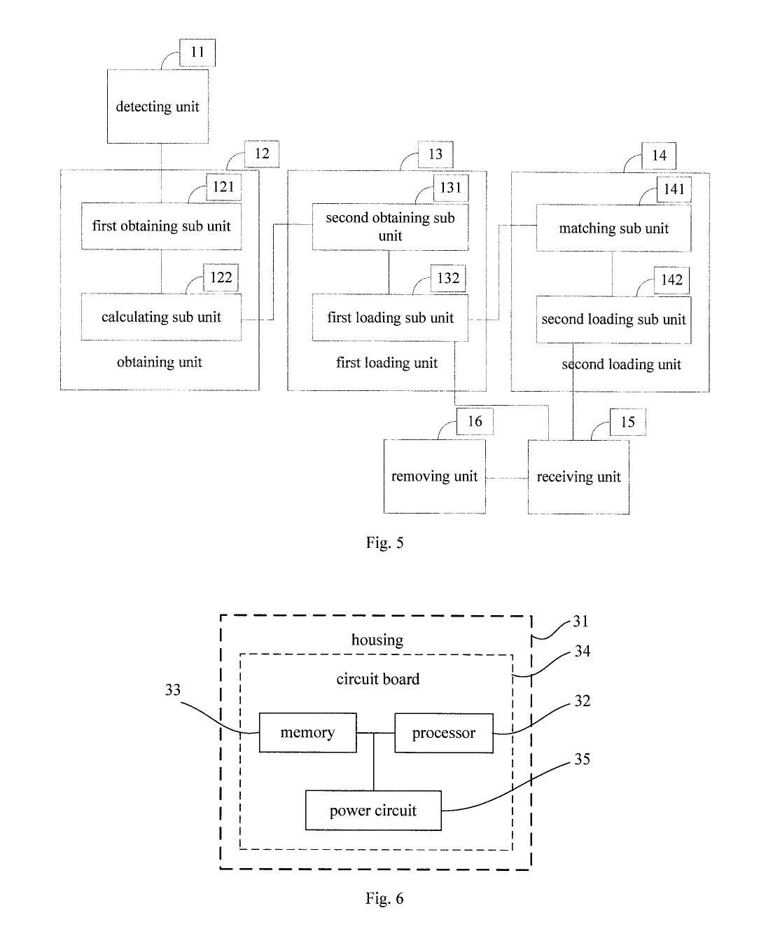

FIG. 5 is a block diagram illustrating a device for loading content of a page according to a second embodiment of the present disclosure. As illustrated in FIG. 5, based on the structure of the device illustrated in FIG. 4, the obtaining unit 12 of the device according to this embodiment may include: a first obtaining sub unit 121 and a calculating sub unit 122. The first obtaining sub unit 121 is configured to obtain a distance between bottom of a currently displayed page and the bottom of the current webpage and a height of the last whole page. The calculating sub unit 122 is configured to determine the ratio of content not displayed in the last whole page to the last whole page according to the distance between the bottom of the currently displayed page and the bottom of the current webpage and the height of the last whole page obtained by the first obtaining sub unit.

Further, the first loading unit 13 may include: a second obtaining sub unit 131 and a first loading sub unit 132. The second obtaining sub unit 131 is configured to obtain a first predetermined number of content data blocks. The first loading sub unit 132 is configured to load the first predetermined number of content data blocks obtained by the second obtaining sub unit below the bottom of the current webpage.

Further, the first loading sub unit 132 may be configured to cache the first predetermined number of content data blocks, and, in response to detecting, by the detecting unit 11, that the current webpage is dragged to, by the user, the bottom of the current webpage and is continuously dragged, load the first predetermined number of content data blocks below the bottom of the current webpage.

Alternatively, the second obtaining unit 131 may be configured to obtain a second predetermined number of content data blocks matching with webpage accessing record of the user.

Further, the device may further include a second loading unit 14 is configured to, after the first loading unit 13 loads the customized content below the bottom of the current webpage, in response to detecting, by the detecting unit 11, that the current webpage is dragged to, by the user, bottom of the loaded customized content and is continuously dragged, loading the second predetermined number of content data blocks below the loaded customized content.

Further, the second loading unit 14 may include: a matching sub unit 141 and a second loading sub unit 142.

The matching sub unit 141 is configured to match the current webpage with a content format base, to obtain the second predetermined number of content data blocks matching with the current webpage.

The second loading sub unit 142 is configured to load the second predetermined number of content data blocks matching with the current webpage below the loaded customized content.

Further, the matching sub unit 141 is configured to obtain a feature of the current webpage, to match the feature of the current webpage with the content format base, and to obtain the second predetermined number of content data blocks matching with the feature of the current webpage.

Further, the device may further include: a receiving unit 15 and a removing unit 16.

The receiving unit 15 is configured to receive a sliding instruction input by the user on the loaded content data blocks.

The removing unit 16 is configured to remove the loaded content data blocks based on the sliding instruction received by the receiving unit 15.

The device according to embodiments of the present disclosure may be used to implement the technical solution of the method embodiment illustrated in FIG. 1 or FIG. 3. Implementation principle and technical effect of the device and the methods are similar, which are not be elaborated herein.

It should be noted that relationship terms such as first and second are only used herein to distinguish an entity or operation from another entity or operation, and it is not necessarily required or implied that there are any actual relationship or order of this kind between those entities and operations. Moreover, terms such as “comprise”, “comprising” and any other variants are intended to cover non-exclusive contains, so that the processes, methods, articles or devices including a series of elements not only include those elements but also include other elements that are not listed definitely, or also include the elements inherent in the processes, methods, articles or devices. In the case of no more restrictions, the elements defined by the statement ‘comprise one . . . ’ do not exclude that other same elements also exist in the processes, methods, articles or devices including the elements.

Each embodiment in the specification is described in a relevant manner. For same or similar parts in the embodiments, reference may be made to each other. What is different from other embodiments is emphasized in each embodiment.

In particular, for the device embodiment, because it is basically similar to the method embodiment, the apparatus embodiment is described simply, and for a relevant part thereof, reference may be made to part of the description of the method embodiment.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination.

In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Embodiments of the present disclosure further provide an electronic device. The electronic device includes the device for loading content of a page according to any one of above-mentioned embodiments.

FIG. 6 is a block diagram illustrating an electronic device according to an embodiment of the present disclosure. The electronic device may implement the processing of embodiment illustrated in FIG. 1 and FIG. 3 of the present disclosure. As illustrated in FIG. 6, above-mentioned electronic device may include: a housing 31, a processor 32, a memory 33, a circuit board 34, and a power circuit 35. The circuit board 34 is arranged inside a space enclosed by the housing 31. The processor 32 and the memory 33 are disposed on the circuit board 34. The power circuit 35 is configured to provide power for individual respective circuits or components of the electronic device. The memory 33 is configured to store executable program codes. The processor 32, by reading the executable program code stored in the memory 33, is configured to run a program corresponding to the executable program codes by reading the executable program codes stored in the memory, so as to perform a method for loading content of a page according to any one of above-mentioned embodiments.

For specific execution processes of the foregoing steps executed by the processor 32 and steps performed by the processor 32 by running the executable program code, reference may be made to the description of the embodiments illustrated in FIG. 1 or FIG. 3 of the present disclosure, and details are not described herein again.

The electronic device may have various forms, including but not limited to follows.

(1) A mobile communication device: this typed device has a capacity of mobile communication, and has a main function of providing voice, data communication. This typed terminal includes a smart phone (such as an iPhone), a multi-media phone, a functional phone and a low-level phone.

(2) A super-mobile personal computer device: this typed device pertains to a personal computer having a capacity of computing and processing and generally having a capacity of accessing mobile Internet. This typed device includes: a PDA (Personal Digital Assistant), a MID (Mobile Internet Device) and UMPC devices (Ultra-mobile Personal Computer), such as an iPad.

(3) Portable entertainment equipment: this typed device may display or play multi-medium content. This typed device includes: an audio and/or video player (such as an iPod), a handheld game player, an E-book, intelligent playthings, and portable vehicle navigation equipment.

(4) A server: a device provides calculation service. The server consists of a processor, a hard disk, a memory, a system bus, etc. The server is similar to universal computer architecture.

However, because of a need to provide highly reliable services, requirements for processing capacity, stability, reliability, security, scalability, and manageability and other aspects are high.

(5) Other electronic device having a capacity of data interaction.

Ordinary skilled in the art can understand that implementation of all or part of the steps carried by the method of the above embodiments can be completed by a program to instruct related hardware. The program can be stored in a computer readable storage medium, when executed, including one or a combination of the steps of the method embodiments.

For the sake of convenience of description, the above description is described in terms of functions described in various units/modules. Certainly, the functionality of each unit/module may be implemented in the same or more software and/or hardware when implementing this disclosure.

It will be apparent to those skilled in the art from the above description of the embodiments that the present disclosure can be implemented by means of software and a necessary universal hardware platform. Based on such understanding, the technical solution of the present disclosure, which is essential or contributes to the prior art, may be embodied in the form of a software product, which may be stored in a storage medium such as a ROM/RAM, a disk, an optical disk, etc., including instructions for causing a computer device (which may be a personal computer, a server, or a network device, etc.) to perform the methods described in respective embodiments or some part of the embodiments of the present disclosure.

What is claimed is:

1. A method for loading content of a page, comprising:
detecting a dragging operation input by a user on a current webpage;
in response to detecting that the current webpage is dragged to, by the user, begin to display content of a last whole page above bottom of the current webpage, obtaining a ratio of content not displayed in the last whole page to the last whole page; and
in response to the ratio being equal to a predetermined ratio, loading customized content below the bottom of the current webpage.

2. The method according to claim 1, wherein obtaining the ratio of content not displayed in the last whole page to the last whole page comprises:
obtaining a distance between bottom of a currently displayed page and the bottom of the current webpage and a height of the last whole page; and
determining the ratio of content not displayed in the last whole page to the last whole page according to the distance between the bottom of the currently displayed page and the bottom of the current webpage and the height of the last whole page.

3. The method according to 1, wherein loading the customized content below the bottom of the current webpage comprises:
obtaining a first predetermined number of content data blocks; and
loading the first predetermined number of content data blocks below the bottom of the current webpage.

4. The method according to claim 3, wherein loading the first predetermined number of content data blocks below the bottom of the current webpage comprises:
caching the first predetermined number of content data blocks; and
in response to detecting that the current webpage is dragged to, by the user, the bottom of the current webpage and is continuously dragged, loading the first predetermined number of content data blocks below the bottom of the current webpage.

5. The method according to claim 3, wherein obtaining the first predetermined number of content data blocks comprises:
obtaining a first predetermined number of content data blocks matching with webpage accessing record of the user.

6. The method according to claim 1, after loading the customized content below the bottom of the current webpage, further comprising:
in response to detecting that the current webpage is dragged to, by the user, bottom of the loaded customized content and is continuously dragged, loading a second predetermined number of content data blocks below the loaded customized content.

7. The method according to claim 6, wherein loading the second predetermined number of content data blocks below the loaded customized content comprises:
matching the current webpage with a content format base, obtaining the second predetermined number of content data blocks matching with the current webpage; and
loading the second predetermined number of content data blocks matching with the current webpage below the loaded customized content.

8. The method according to claim 7, wherein matching the current webpage with a content format base, obtaining the second predetermined number of content data blocks matching with the current webpage comprises:
obtaining a feature of the current webpage; and
matching the feature of the current webpage with the content format base, obtaining the second predetermined number of content data blocks matching with the feature of the current webpage.

9. The method according to claim 6, further comprising:
receiving a sliding instruction input by the user on the loaded content data blocks; and
removing the loaded content data blocks based on the sliding instruction.

10. An electronic device, comprising: a housing, a processor, a memory, a circuit board, and a power circuit, wherein the circuit board is arranged inside a space enclosed by the housing; the processor and the memory are disposed on the circuit board; the power circuit is configured to provide power for individual respective circuits or components of the electronic device; the memory is configured to store executable program codes; and the processor, by reading the executable program code stored in the memory, is configured to run a program corresponding to the executable program codes by reading the executable program codes stored in the memory, so as to perform following actions:
detecting a dragging operation input by a user on a current webpage;
in response to detecting that the current webpage is dragged to, by the user, begin to display content of a last whole page above bottom of the current webpage, obtaining a ratio of content not displayed in the last whole page to the last whole page; and
in response to the ratio being equal to a predetermined ratio, loading customized content below the bottom of the current webpage.

11. The electronic device according to claim 10, wherein obtaining the ratio of content not displayed in the last whole page to the last whole page comprises:
obtaining a distance between bottom of a currently displayed page and the bottom of the current webpage and a height of the last whole page; and
determining the ratio of content not displayed in the last whole page to the last whole page according to the distance between the bottom of the currently displayed page and the bottom of the current webpage and the height of the last whole page.

12. The electronic device according to 10, wherein loading the customized content below the bottom of the current webpage comprises:
obtaining a first predetermined number of content data blocks; and
loading the first predetermined number of content data blocks below the bottom of the current webpage.

13. The electronic device according to claim 12, wherein loading the first predetermined number of content data blocks below the bottom of the current webpage comprises:
caching the first predetermined number of content data blocks; and
in response to detecting that the current webpage is dragged to, by the user, the bottom of the current webpage and is continuously dragged, loading the first predetermined number of content data blocks below the bottom of the current webpage.

14. The electronic device according to claim 12, wherein obtaining the first predetermined number of content data blocks comprises:
obtaining a first predetermined number of content data blocks matching with webpage accessing record of the user.

15. The electronic device according to claim 10, after loading the customized content below the bottom of the current webpage, the processor is further configured to perform:
in response to detecting that the current webpage is dragged to, by the user, bottom of the loaded customized content and is continuously dragged, loading a second predetermined number of content data blocks below the loaded customized content.

16. The electronic device according to claim 15, wherein loading the second predetermined number of content data blocks below the loaded customized content comprises:
matching the current webpage with a content format base, obtaining the second predetermined number of content data blocks matching with the current webpage; and
loading the second predetermined number of content data blocks matching with the current webpage below the loaded customized content.

17. The electronic device according to claim 16, wherein matching the current webpage with a content format base, obtaining the second predetermined number of content data blocks matching with the current webpage comprises:
obtaining a feature of the current webpage; and
matching the feature of the current webpage with the content format base, obtaining the second predetermined number of content data blocks matching with the feature of the current webpage.

18. The electronic device according to claim 15, the processor is further configured to perform:
receiving a sliding instruction input by the user on the loaded content data blocks; and
removing the loaded content data blocks based on the sliding instruction.

19. A non-transitory computer storage medium, configured to store an application, wherein the application is configured to perform following actions:
detecting a dragging operation input by a user on a current webpage;
in response to detecting that the current webpage is dragged to, by the user, begin to display content of a last whole page above bottom of the current webpage, obtaining a ratio of content not displayed in the last whole page to the last whole page; and
in response to the ratio being equal to a predetermined ratio, loading customized content below the bottom of the current webpage.

20. The storage medium according to claim 19, wherein obtaining the ratio of content not displayed in the last whole page to the last whole page comprises:
obtaining a distance between bottom of a currently displayed page and the bottom of the current webpage and a height of the last whole page; and
determining the ratio of content not displayed in the last whole page to the last whole page according to the distance between the bottom of the currently displayed page and the bottom of the current webpage and the height of the last whole page.
